(19) United States
(12) Patent Application Publication
(10) Pub. No.: US 2012/0152149 A1
(43) Pub. Date: Jun. 21, 2012

(54) USE OF 1,3-DIOLS AS BIOCIDES

(75) Inventors: Darijo Mijolovic, Mannheim (DE); Volker Wendel, Seeheim-Jugenheim (DE); Anja Suckert, Mannheim (DE)

(73) Assignee: BASF SE, Ludwigshafen (DE)

(21) Appl. No.: 13/391,751

(22) PCT Filed: Aug. 16, 2010
(86) PCT No.: PCT/EP2010/061897

§ 371 Date: Feb. 22, 2012

(30) Foreign Application Priority Data
Aug. 26, 2009 (EP) 09168700.4

(51) Int. Cl. C09D 5/14

(52) U.S. Cl. 106/15.05

(57) ABSTRACT

Use of a diol as biocidal active ingredient, wherein it is a diol of the formula I

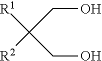

in which R1 and R2, independently of one another, are an organic radical having in each case at least one carbon atom, or R1 and R2 together form a ring system of at least 4 carbon atoms, which may be optionally substituted (referred to hereinbelow in summary for short as 1,3-diol).

The invention relates to a use of a diol as biocidal active ingredient, wherein the diol is one of the formula I

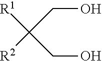

in which R1 and R2, independently of one another, are an organic radical having in each case at least one carbon atom, or R1 and R2 together form a ring system of at least 4 carbon atoms, which may be optionally substituted (referred to hereinbelow in summary for short as 1,3-diol).

Biocidal active ingredients kill microorganisms such as bacteria, fungi, yeasts, algae or viruses or at least prevent their reproduction and/or growth.

For a very wide variety of substrates, there is the desire and often also the need for a biocidal finish. These are, for example, substrates for medical applications, applications in the sanitary or hygiene sector, in the food sector, especially in food packagings, or substrates for diverse industrial applications, in particular filters, etc. for air conditioning systems.

Biocides are also used as preservatives. Of particular importance here is the use as preservative for liquid preparations which are used for medicinal, hygiene, cosmetic or dermatological purposes.

Biocidal effects have been established for various chemical compounds. In connection with alcohols, it is known that 1,2-alkanediols have a good biocidal effect, as is also described by Gerhard Schmaus, Antje Pfeiffer, Sabine Lange and Aurélie Trunet in Cosmetics & Toiletries, vol. 123, No. 10, October 2008, pages 53 to 64.

Alternative solutions are constantly being sought for the diverse uses of biocidal active ingredients.

The object of the present invention was therefore biocidal active ingredients which have a good biocidal effect against as many microorganisms as possible, are easy to handle and can be used in diverse ways.

Accordingly, the use defined at the start has been found.

The diol used according to the invention is a diol of the formula I

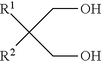

Diols of the formula I are also referred to hereinbelow as 1,3-diol or 1,3-diols.

In formula I, R1 and R2, independently of one another, are an organic radical having in each case at least one carbon atom (1st alternative), moreover R1 and R2 together can form a ring system of at least 4 carbon atoms, which may be optionally substituted (2nd alternative).

In one preferred embodiment to the 1st alternative, R1 and R2, independently of one another, are a hydrocarbon radical having 1 to 12 carbon atoms. These may be aliphatic, cycloaliphatic or aromatic hydrocarbon radicals. Suitable aliphatic hydrocarbon radicals are in particular alkyl groups; a suitable cycloaliphatic hydrocarbon radical is e.g. the cyclohexyl group, and a suitable aromatic hydrocarbon radical is in particular the phenyl group.

Particularly preferably, R1 and R2, independently of one another, are a C1 to C12-alkyl group, particularly preferably a C1-C10 alkyl group. The two alkyl groups can, independently of one another, be linear or branched. Preferably, the sum of the carbon atoms in R1 and R2 is at most 16, in particular at most 12.

In one preferred embodiment to the 2nd alternative, R1 and R2 together form a cycloaliphatic ring system. The ring system can be substituted by further organic groups, e.g. alkyl groups. It is particularly preferably an unsubstituted cycloaliphatic ring system. The cycloaliphatic ring system can optionally also comprise one or two double bonds. The ring system consists preferably of at most 12 carbon atoms (sum of all carbon atoms in R1 and R2, including the carbon atom to which R1 and R2 are bonded).

Suitable 1,3-diols are specified below.

1,3-Diols of the 1st alternative with an aromatic or cycloaliphatic radical:

2-methyl-2-phenylpropane-1,3-diol (MPPD)

2-cyclohexyl-2-methylpropane-1,3-diol (CHMPD)

1,3-Diols of the 1st alternative with exclusively alkyl groups as R1 and R2:

2-ethyl-2-methylpropane-1,3-diol (EMPD)

2-butyl-2-ethylpropane-1,3-diol (BEPD)

2-pentyl-2-propylpropane-1,3-diol (PPPD)

2-(2-methylbutyl)-2-propylpropane-1,3-diol (MBPPD)

2-isopropyl-2-methylpropane-1,3-diol (IMPD)

2-isopropyl-2-(3-methylbutyl)propane-1,3-diol (IMBPD)

2-octyl-2-methylpropane-1,3-diol (OMPD)

1,3-Diols of the 2nd alternative:

1,1-dimethylolcyclopentane (DMCP)

1,1-dimethylolcyclohexane (DMCH)

1,1-dimethylolcyclooct-4-ene (DMCOE)

1,1-dimethylolcyclooctane (DMCO)

1,1-dimethylolcyclododecane (DMCD)

2,2-dimethylolnorbornane (2,2-DMNB)

The aforementioned 1,3-diols and their preparation are known.

As an overview, the structural formulae of the aforementioned diols and the associated CAS numbers are listed below:

| 1,3-Diols | |
|---|---|
| 1st alternative | |
| EMPD | 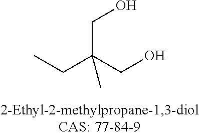 |
| BEPD | 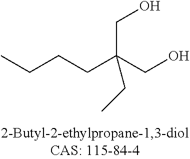 |
| PPPD | 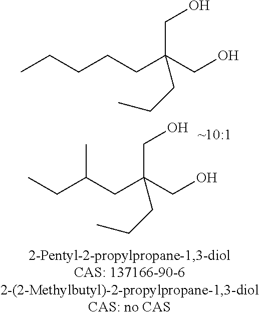 |
| IMPD | 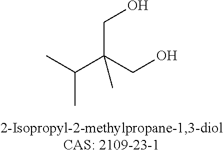 |
| IMBPD | 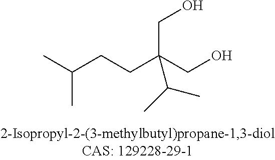 |
| OMPD | 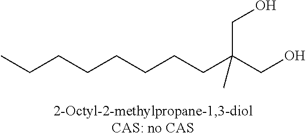 |
| MPPD | 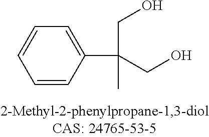 |
| CHMPD | 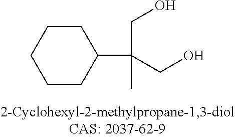 |
| 1,3-Diols | |
| 2nd alternative | |
| DMCP | 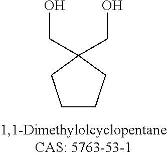 |
| DMCH | 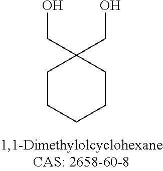 |
| DMCOE | 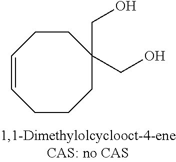 |
| DMCO | 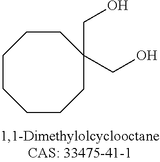 |
| DMCD | 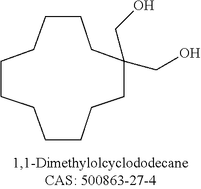 |
| 2,2-DMNB | 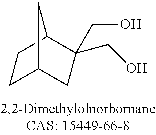 |

The preparation of PPPD and MBPPD is described e.g. also in PCT/EP 2009/057133 (PF 60933); a preferred procedure described therein produces mixtures of PPPD and MPPPD which can be used within the context of this invention.

The preparation of 1,3-diols of the 1st alternative, in which a radical R1 or R2 is an isopropyl group, is also described in PCT/EP2009/059326 (PF 61057).

The preparation of 1,3-diols of the 1st alternative, in which a radical R1 or R2 is a phenyl group or cycloaliphatic group, is also described in PCT/EP (later) (PF 61188).

Of particular suitability for the use according to the invention are also mixtures of the above diols. The above 1,3-diols may of course also be used in combination with other biocides (cf. Table 1).

Use

The compounds described in this invention have a significant antimicrobial effect, e.g. against Gram-positive and Gram-negative bacteria, against yeasts and molds. They are therefore suitable for the disinfection of a very wide variety of surfaces and objects, for the deodorization of surfaces and objects and various regions of the body, and also for the general antimicrobial treatment of skin and mucosa, technical materials.

The 1,3-diols are suitable for the biocidal finishing of moldings.

The 1,3-diols can be applied to the moldings as such or in the form of a liquid preparation. By using liquid preparations which comprise 1,3-diols, it is generally possible to achieve better distribution of the 1,3-diols on the surface.

Suitable liquid preparations are solutions or emulsions of the 1,3-diols in a solvent. Suitable solvents are water or organic solvents, e.g. alcohols and ethers. The liquid preparations can comprise further biocides or other additives, as also described by R. Gächter, H. Müller in Taschenbuch der Kunststoffadditive, 3rd Edition, 1990, ISBN 3-446-15627-5. Further biocides are specified in particular in Chapter 15 “Biostabilizers”, 823 ff.

Biocidally finished moldings are obtainable by coating, impregnating or treating in some other way the desired moldings with the 1,3-diol, or its solution or emulsion. The treatment with the solution or emulsion can take place at room temperature, and after the drying the molding correspondingly has a biocidal finish.

The amount of 1,3-diol here can be e.g. 0.001 to 1000 mg, particularly preferably 0.1 to 10 mg of 1,3-diol per square meter of surface of the molding to be finished with the biocide.

The term molding is to be understood here as meaning any desired objects which are present in a defined form, in contrast to liquids or gases.

Mention may be made, for example, of textiles of natural or synthetic materials. These materials can be colored or uncolored or printed and e.g. consist of silk, wool, polyamides, polyurethanes or of cellulose fibers of any type. Such fibers are e.g. cotton, linen, jute or hemp.

Nonwoven materials (nonwovens), such as e.g. diapers, sanitary napkins or items of clothing for medical, hygiene or household sectors, can be antimicrobially finished with diols within the meaning of the invention.

The antimicrobial substances of this invention can also be used for the treatment, particularly the antimicrobial finishing, or the preservation of moldings made of plastic, e.g. films or containers made of plastic, other plastics packagings, paper, cardboard, moldings made of metal or moldings made of combinations of different materials. Examples thereof are floor coverings, plastic coverings, plastic containers and packaging materials, kitchen and bath utensils, plastic articles in medical applications, such as feeding material, syringes, catheters or gloves, for applications in the sanitary and hygiene sector, for the packaging or storage of foods or for industrial purposes, e.g. filters in air conditioning systems.

The moldings finished with the 1,3-diol are in particular moldings for medical applications, for applications in the sanitary and hygiene sector, for the packing or storage of foods or for industrial purposes, e.g. filters in air conditioning systems.

The 1,3-diols are also suitable as preservatives in liquid preparations, in gaseous preparations, sprays, foams or gels.

The antimicrobial substances of this invention can also be used for the treatment, particularly the antimicrobial finishing, or the preservation of industrial formulations, such as e.g. paints, lacquers or coatings.

If the antimicrobially finished formulation is a coating, then it can be present in the form of a liquid, a solution or suspension, a paste, a gel or an oil, or else in solid form, e.g. as powder, which is then cured by irradiation with UV light, heat or other methods.

Paper which is used for hygiene purposes can also be equipped with the antimicrobial properties of this invention.

The antimicrobial substances of this invention can also be used in detergent or cleaner formulations, e.g. liquid or powder detergents or fabric softeners.

The substances of this invention can also be used in domestic and all-purpose cleaners for the cleaning and/or disinfection of surfaces.

The diols of this invention can likewise be used for the antimicrobial treatment of wood or leather or for the preservation of leather or for the antimicrobial finishing of leather.

The substances described here can also be used to protect cosmetic preparations, pharmaceutical products or household products against microbial damage.

The antimicrobial substances of this invention can also be used in crop protection in order to protect plants in fields or woods, plant parts or seed material against diseases or spoilage. Corresponding compositions consist of at least one of the diols of this invention. The composition can be applied to seedlings, seed or the soil.

Cosmetic Products

The invention comprises personal care compositions which comprise one or more of the described diols, either alone or in combination with nonionic surfactants and/or anionic surfactants and/or cationic surfactants and/or amphoteric surfactants. The diols are used here in an effective concentration which preserves the composition and/or leads to an antimicrobial effect on the surface to which it is applied.

A large variety of cosmetic preparations comprise antimicrobial active ingredients. The following preparations, for example, are in particular contemplated in this regard:
skin care products, e.g. skin washing and cleaning products in the form of bar soaps, liquid soap, soap-free products,
bath products, e.g. liquid shower/bath products (foam baths, milk, shower gels) or solid products, e.g. soap bars or bath salts
skin care products, such as e.g. emulsions, multi-emulsions or oils
cosmetic products, such as e.g. face make-up in the form of a day cream or powder cream, face powder, blusher or cream make-up, eye care products, such as e.g. eye shadows, mascara, eye liner, lip care products, such as e.g. lipsticks, lip gloss, nail care products, such as e.g. nail varnish, nail varnish removers, nail hardeners
foot care products, such as e.g. foot baths, foot powders, foot creams, foot balsam, especially deodorants and antiperspirants
light protecting preparations, such as e.g. sun milk, lotions, creams or oils, self-tanning products or after-sun products
anti-insect compositions, such as e.g. oils, lotions, sprays or sticks
deodorants, such as e.g. sprays, deodorant aerosols, pump sprays, deodorant gels, sticks or roll-ons and also anhydrous deodorant aerosols or sticks
antiperspirants, such as e.g. antiperspirant sticks, creams, roll-ons, including anhydrous antiperspirant sticks or aerosols
products for cleaning and care products, such as e.g. scrubs and masks
hair-removal products in chemical form, such as e.g. powdery or liquid preparations, creams or pastes or gels or aerosol foams
shaving products, such as e.g. shaving soap, foaming shaving cream, non-foaming shaving cream, foams or gels, preshave products for dry shaving, aftershaves or aftershave lotions
perfume products, such as e.g. perfume oils or perfume creams
cosmetic hair care products, such as e.g. hair washing products in the form of shampoos or conditioners, hair care products, such as e.g. hair tonics, styling creams, styling gels, pomades, hair rinses, hair treatments, products for producing and caring for curls, hair-smoothing products, foam setting compositions, hair sprays, hair colors, hair tints
antidandruff products in the form of shampoos, conditioners, hair tonics, styling creams or gels, or hair treatments.

Corresponding cosmetic preparations can come in a large variety, e.g.
in the form of liquid preparations such as W/O, O/W, O/W/O, W/O/W or PIT emulsions all types of microemulsions
in the form of a gel,
in the form of an oil, a cream, milk or lotion
in the form of a powder, a varnish, a make-up
in the form of a stick
in the form of a spray (as pump-spray or as spray with propellant gas) or an aerosol
in the form of a foam or
in the form of a paste.

The cosmetic or pharmaceutical preparations can be present e.g. as cream, gel, lotion, alcoholic or aqueous/alcoholic solution, wax/fat product, stick, powder or ointment.

As water and oil-containing emulsions, e.g. W/O, O/W, O/W/O and W/O/W emulsions or microemulsions or PIT emulsions are present. These preparations comprise e.g. from 0.01 to 30% w/w, preferably from 0.1 to 15% w/w and particularly preferably from 0.5 to 10% w/w of an antimicrobial active ingredient. They include at least one oil component from 0 to 30% w/w, particularly from 1 to 30% w/w and particularly preferably from 4 to 20% w/w, based on the total weight of the formulation. These preparations also comprise at least one emulsifier from 10 to 90% w/w, particularly from 30 to 90% w/w, of water from 0 to 88.9% w/w, particularly from 1 to 50% w/w and of further cosmetically acceptable additives.

The personal care products mentioned here comprise diols in a physiologically acceptable medium. This means that the formulation is non-toxic, non-irritative and is suitable for contact with surfaces of the human body. Such surfaces include e.g. hair, skin, mucosa, teeth. Whether the composition is physiologically acceptable can be determined by means of tests in accordance with the prior art.

Household Products and Technical Products

The term “household products” describes, a composition which is used in the typical vicinity of people. These products are generally nontoxic. The preparation in the “household product” category can comprise at least one further ingredient in addition to surfactants or alcohols. These additives can be either soluble or insoluble. These may be e.g. further antimicrobial active ingredients, enzymes, bleaches, whiteners, color care substances, fabric softeners, color transfer inhibitors, complexing agents, aerosol propellant gases and they can also comprise surfactants or further alcohols.

The preparations in the “domestic product” category can be present in very diverse forms, such as e.g. in an aqueous, nonaqueousor oil phase. And they can also comprise emulsifiers, and also gelling agents or thickeners. These preparations can be in the form of a liquid, paste, gel, bars, tablets, sprays, foams, powders or granules.

Further Antimicrobial Active Ingredients

The diols described here can be present either on their own or in combination with one or more other antimicrobial active ingredients and/or biocides and be used for e.g. pot preservation or for the preservation of cosmetic or pharmaceutical products, for the preservation of personal care products, such as e.g. toiletries, mouth care products, for preserving domestic products, such as e.g. all-purpose cleaners, detergents or fabric softeners and further products with a corresponding water fraction which have to be protected by preservation as a result of microbial decay.

An “antimicrobial active ingredient” is a substance which is able to bring about an antimicrobial effect. The present invention comprises antimicrobial active ingredients which have bacteriostatic, bacteriocidal, virucidal, virostatic, fungistatic or fungicidal activity.

The substances of the present invention can also be used together with biogenically active ingredients. These are e.g. tocopherol, tocopherol acetate, tocopherol palmitate, ascorbic acid, deoxyribonucleic acid, retinol, bisabolol, allantoin, phytantriol, panthenol, AHA acids, amino acids, ceramides, essential oils, plant extracts and vitamins.

Examples of “additional antimicrobial active ingredients” which are used in connection with the substances of the present invention described here are: pyrithiones, particularly zinc complexes (ZPT); Octopirox®; Climbazol®, selenium sulfide, dimethyldimethylol hydantoin (Glydant®); methylchloroisothiazolinone/methyl-isothiazolinone (Kathon CG®); sodium sulfite; sodium bisulfite; imidazolidinyl urea (Germall 115®), diazolidinyl urea (Germaill II®); benzyl alcohol; 2-bromo-2-nitropropane-1,3-diol (Bronopol®); formalin (formaldehyde); iodopropenyl butylcarbamate (Polyphase P100®); chloroacetamide; methanamine; methyldibromonitrile glutaronitrile(1,2-dibromo-2,4-dicyanobutane or Tektamer®); glutaraldehyde; 5-bromo-5-nitro-1,3-dioxane (Bronidox®); phenethyl alcohol; o-phenylphenol/sodium o-phenylphenol; sodium hydroxymethylglycinate (Suttocide A®); polymethoxy bicyclic oxazolidine (Nuosept C®); dimethoxane; thiomersal; dichlorobenzyl alcohol; captan; chlorphenesin; dichlorophene; chlorobutanol; glyceryl laurate; halogenated diphenyl ether; 2,4,4′-trichloro-2′-hydroxydiphenyl ether (Triclosan® or TCS); 2,2′-dihydroxy-5,5′-dibromodiphenyl ether; phenolic substances; phenol; 2-methylphenol; 3-methylphenol; 4-methylphenol; 4-ethylphenol; 2,4-dimethylphenol; 2,5-dimethylphenol; 3,4-dimethylphenol; 2,6-dimethylphenol; 4-n-propylphenol; 4-n-butylphenol; 4-n-amylphenol; 4-tert-arnylphenol; 4-n-hexylphenol; 4-n-heptylphenol; mono- and polyalkyl and aromatic halophenols; p-chlorophenol; methyl p-chlorophenol; ethyl p-chlorophenol; n-propyl p-chlorophenol; n-butyl p-chlorophenol; n-amyl p-chlorophenol; sec-amyl p-chlorophenol; cyclohexyl p-chlorophenol; n-heptyl p-chlorophenol; n-octyl p-chlorophenol; o-chlorophenol; methyl o-chlorophenol; ethyl o-chlorophenol; n-propyl o-chlorophenol; n-butyl o-chlorophenol; n-amyl o-chlorophenol; tert-amyl o-chlorophenol; n-hexyl o-chlorophenol; n-heptyl o-chlorophenol; o-benzyl p-chlorophenol; o-benzyl-m-methyl p-chlorophenol, o-benzyl-m,m-dimethyl p-chlorophenol; o-phenylethyl p-chlorophenol; o-phenylethyl-m-methyl p-chlorophenol; 3-methyl p-chlorophenol; 3,5-dimethyl p-chlorophenol; 6-ethyl-3-methyl p-chlorophenol; 6-n-propyl-3-methyl p-chlorophenol; 6-isopropyl-3-methyl p-chlorophenol; 2-ethyl-3,5-dimethyl p-chlorophenol; 6-sec-butyl-3-methyl p-chlorophenol; 2-iso-propyl-3,5-dimethyl p-chlorophenol; 6-diethylmethyl-3-methyl p-chlorophenol; 6-iso-propyl-2-ethyl-3-methyl p-chlorophenol; 2-sec-amyl-3,5-dimethyl p-chlorophenol; 2-diethyl-methyl-3,5-dimethyl p-chlorophenol; 6-sec-octyl-3-methyl p-chlorophenol; p-chloro-m-cresol, p-bromophenol; methyl p-bromophenol; ethyl p-bromophenol; n-propyl p-bromophenol; n-butyl p-bromophenol; n-amyl p-bromophenol; sec-amyl p-bromophenol; n-hexyl p-bromophenol; cyclohexyl p-bromophenol; o-bromophenol; tert-amyl o-bromophenol; n-hexyl o-bromophenol; n-propyl-m,m-dimethyl o-bromophenol; 2-phenyl phenol; 4-chloro-2-methylphenol; 4-chloro-3-methylphenol; 4-chloro-3,5-dimethylphenol; 2,4-dichloro-3,5-dimethylphenol; 3,4,5,6-terabromo-2-methylphenol; 5-methyl-2-pentylphenol; 4-isopropyl-3-methylphenol; para-chlorometaxylenol (PCMX); chlorothymol; phenoxyethanol; phenoxyisopropanol; 5-chloro-2-hydroxydiphenylmethane; resorcinol and its derivatives; resorcinol; methyl resorcinol; ethyl resorcinol; n-propyl resorcinol; n-butyl resorcinol; n-amyl resorcinol; n-hexyl resorcinol; n-heptyl resorcinol; n-octyl resorcinol; n-nonyl resorcinol; phenyl resorcinol; benzyl resorcinol; phenylethyl resorcinol; phenylpropyl resorcinol; p-chlorobenzyl resorcinol; 5-chloro-2,4-dihydroxydiphenylmethane; 4′-chloro-2,4-dihydroxydiphenylmethane; 5-bromo-2,4-dihydroxydiphenylmethane; 4′-bromo-2,4-dihydroxydiphenylmethane; bisphenolic compounds; 2,2′-methylene bis(4-chlorophenol); 2,2′-methylene bis(3,4,6-trichlorophenol); 2,2′-methylene bis(4-chloro-6-bromophenol); bis(2-hydroxy-3,5-dichlorophenyl)sulfide; bis(2-hydroxy-5-chlorobenzyl)sulfide; benzoic acid esters (parabens); methylparaben; propylparaben; butylparaben; ethylparaben; isopropylparaben; isobutylparaben; benzylparaben; sodium methylparaben; sodium propylparaben; halogenated carbanilides; 3,4,4′-trichlorocarbanilides (Triclocarban® or TCC); 3-trifluoromethyl-4,4′-dichlorocarbanilide; 3,3′,4-trichlorocarbanilide; chlorohexidine and digluconates thereof; diacetates and dihydrochlorides; undecanoic acid; thiabendazole, hexetidine; poly(hexamethylenebiguanide)hydrochloide (Cosmocil®); silver components such as e.g. organic or inorganic silver salts, formulations containing silver chloride, e.g. like JM Acticare® and micronized silver particles or dissolved silver salts, such as e.g. TinosanSDC®. In particular, mixtures of the additional antimicrobial active ingredients are also suitable.

For the purpose of preserving cosmetic, pharmaceutical products, household products and technical products, combinations of the diols described here together with “other antimicrobial preservatives” exhibit particular activities. These are those which are specified in Annex V of the European Cosmetics Ordinance: formaldehyde; paraformaldehyde; hydroxybiphenyls and corresponding salts such as orthophenylphenol; zinc pyrithione; chlorobutanol; hydroxybenzoic acid and its salts and esters, such as methyl paraben, ethyl paraben, propyl paraben, butyl paraben; dibromo hexamidine and its salts including isethionate(4,4′-hexamethylenedioxybis(3-bromobenzamidine) and 4,4′-hexamethylenedioxybis(3-bromobenzamidinium 2-hydroxyethanesulfonate); mercury, (aceto-O)phenyl (i.e. phenyl mercuric acetate) and mercurate(2-),(orthoboate(3-)—O)phenyl, dihydrogene (i.e. phenyl mercuric borate); 1,3-bis(2-ethylhexyl)-hexahydro-5-methyl-5-pyrimidine (hexetidine); 5-bromo-5-nitro-1,3-dioxane; 2-bromo-2-nitro-1,3-propanediol; 2,4-dichlorobenzyl alcohol; 3,4,4′trichlorocarbanilide(trichlorocarban); p-chloro-m-cresol; 2,4,4′-trichloro-2-hydroxydiphenyl ether(triclosan); 4,4′-dichloro-2-hydroxydiphenyl ether; 4-chloro-3,5-dimethylphenol(chloroxylenol); imidazolidinyl urea; poly(hexamethylene biguanide)hydrochloride; 2-phenoxyethanol(phenoxyethanol); hexamethylenetetramine(methenamine); 1-(3-chloroallyl)-3,5,7-triaza-1-azoniaadamantan chloride(quaternium 15); 1-(4-chlorophenyoxy)-1-(1-imidazolyl)3,3-dimethyl-2-butanone(climbazole); 1,3-bis(hydroxymethyl)-5,5-dimethyl-2,4-imidazolidinedione (DMDM hydantoin); benzyl alcohol; 1,2-dibromo-2,4-dicyanobutane; 2,2′-methylenebis(6-bromo-4-chlorophenol)(bromochlorophene); methylchloroisothiazolone, methylisothiazolone, octylisothiazolone, benzylisothiazolone; 2-benzyl-4-chlorophenol(chlorophenone); chloroacetamide; chlorhexidine, chlorhexidine acetate, chlorhexidine gluconate, chlorhexidine hydrochloride; 1-phenoxy-propan-2-ol (phenoxyisopropanol); 4,4-dimethyl-1,3-oxazolidine(dimethyl oxazolidine); diazolidinylurea; 4,4′-hexamethylenedioxybisbenzamidine and 4,4′-hexamethylenedioxybis(benzamidinium-2-hydroxyethanesulfonate); glutaraldehyde(1,5-pentanedial); 7-ethylbicyclooxazolidine; 3-(4-chlorophenoxy)-1,2-propanediol(chlorphenesin); phenylmethoxymethanol and ((phenylmethoxy)methoxy)methanol(benzylhemiformal); N-alkyl(C12-C22)trimethyl ammonium bromide and chloride (cetrimonium, cetrimonium chloride); benzyldimethyl(4-(2-(4-(1,1,3,3-tetramethylbutyl)phenoxy)ethoxy)ethyl)ammonium chloride (benzethonium chloride); alkyl(C8-C18)dimethylbenzylammonium chloride, bromide and saccharinate; (benzalkonium chloride, benzalkonium bromide, benzalkonium saccharinate); benzoic acid and its salts and esters; propionic acid and its salts; salicylic acid and its salts, sorbic acid and its salts, sodium iodinate; inorganic sulfites and bisulfites such as sodium sulfite; dehydroacetic acid; formic acid; mercurate(1-ethyl)2-mercaptobenzoate(2-)—O, S—, hydrogen (thiomersal or thiomerosal); 10-undecylenic acid and corresponding salts; octopirox (piroctone olamine); sodium hydroxyl methylaminoacetate (sodium hydroxymethylglycinate); silver components, such as those in JM ActiCare or silver complexes such as e.g. Tinosan SDC® and others (WO-A-99/18790, EP1041879B1); and 3-iodo-2-propynyl butylcarbamate. In particular, mixtures of the aforementioned antimicrobial preservatives are also suitable.

The invention also comprises compositions which include other “natural antimicrobial active ingredients”. These may be proteins, corresponding peptides on their own or combined with one another, natural essential oils or their derivatives. A number of natural oils which have antibacterial activity include oils of anise, lime, orange, rosemary, thyme, lavender, tea tree, lemon, wheat, lemongrass, cedar, cinnamon, eucalyptus, peppermint, basil, fennel, menthol, ocmea origanum, Hydastis carradensis, Berberidaceae daceae, Ratanhiae and Curcuma longa. In particular, mixtures of the aforementioned antimicrobial preservatives are also suitable.

In order to achieve the broadest possible activity spectrum, better formulatability or better handling for the manufacturers of household products or personal care products, mixtures of different antimicrobial active ingredients are supplied which are used as preservatives or as antimicrobial active substance, which impart particular antimicrobial properties to the end product.

For this, concentrated mixtures of biocidal substances, previously as “additional antimicrobial active ingredients” and/or “other antimicrobial preservatives” are mixed together in a ratio in order to obtain therefrom raw materials which can be used in the formulation of household products or personal care products.

The concentration of the individual biocidal substances in the BIOCIDE combinations (mixtures) are between 1% and 99%, in particular between 10% and 90%. The use concentration of these BIOCIDE combinations in household products and personal care products is typically in the range from 0.05% to 5% and in particular in the range from 0.05% to 2%.

Further biocide combinations are e.g.:

In all of the BIOCIDE combinations (mixtures) listed previously, the weight ratio of the biocides for combinations of two biocides is 1:1 or 1:2 or 1:3 or 1:4 or 1:5 or 1:6 or 1:7 or 1:8 or 1:9 or 1:10 or 2:1 or 3:1 or 4:1 or 5:1 or 6:1 or 7:1 or 8:1 or 9:1 or 10:1. In some cases, the ratio can even between 1:10 and 1:100 or 10:1 and 100:1.

In formulations, the following may be present:

“Diol” as described in the table “1,3-diols”, possibly used in combination with further biocides.

“BIOCIDE” can be (as shown in Table 1) BIOCIDE 1, or BIOCIDE 2, or BIOCIDE 3, or BIOCIDE 4, or BIOCIDE 5, or BIOCIDE 6, or BIOCIDE 7, or BIOCIDE 8, or BIOCIDE 9, or BIOCIDE 10, or BIOCIDE 11, or BIOCIDE 12, or BIOCIDE 13, or BIOCIDE 14, or BIOCIDE 15, or BIOCIDE 16, or BIOCIDE 17, or BIOCIDE 18, or BIOCIDE 19, or BIOCIDE 20, or BIOCIDE 21, or BIOCIDE 22, or BIOCIDE 23, or BIOCIDE 24, or BIOCIDE 25, or BIOCIDE 26, or BIOCIDE 27, or BIOCIDE 28, or BIOCIDE 29, or BIOCIDE 30, or BIOCIDE 31, or BIOCIDE 32, or BIOCIDE 33, or BIOCIDE 34, or BIOCIDE 35, or BIOCIDE 36, or BIOCIDE 37, or BIOCIDE 38, or BIOCIDE 39, or BIOCIDE 40, or BIOCIDE 41, or BIOCIDE 42, or BIOCIDE 43, or BIOCIDE 44, or BIOCIDE 45, or BIOCIDE 46, or BIOCIDE 47, or BIOCIDE 48, or BIOCIDE 49, or BIOCIDE 50, or BIOCIDE 51, or BIOCIDE 52, or BIOCIDE 53, or BIOCIDE 54, or BIOCIDE 55, or BIOCIDE 56, or BIOCIDE 57, or BIOCIDE 58, or BIOCIDE 59, or BIOCIDE 60, or BIOCIDE 61, or BIOCIDE 62, or BIOCIDE 63, or BIOCIDE 64, or BIOCIDE 65, or BIOCIDE 66, or BIOCIDE 67, or BIOCIDE 68, or BIOCIDE 69, or BIOCIDE 70, or BIOCIDE 71, or BIOCIDE 72, or BIOCIDE 73, or BIOCIDE 74, or BIOCIDE 75, or BIOCIDE 76, or BIOCIDE 77, or BIOCIDE 78, or BIOCIDE 79, or BIOCIDE 80, or BIOCIDE 81, or BIOCIDE 82, or BIOCIDE 83, or BIOCIDE 84, or BIOCIDE 85, or BIOCIDE 86, or BIOCIDE 87, or BIOCIDE 88, or BIOCIDE 89, or BIOCIDE 90, or BIOCIDE 91, or BIOCIDE 92, or BIOCIDE 93, or BIOCIDE 94, or BIOCIDE 95, or BIOCIDE 96, or BIOCIDE 97, or BIOCIDE 98, or BIOCIDE 99, or BIOCIDE 100, or BIOCIDE 101, or BIOCIDE 102, or BIOCIDE 103, or BIOCIDE 104, or BIOCIDE 105, or BIOCIDE 106, or BIOCIDE 107, or BIOCIDE 108, or BIOCIDE 109, or BIOCIDE 110, or BIOCIDE 111, or BIOCIDE 112, or BIOCIDE 113, or BIOCIDE 114, or BIOCIDE 115, or BIOCIDE 116, or BIOCIDE 117, or BIOCIDE 118, or BIOCIDE 119, or BIOCIDE 120, or BIOCIDE 121, or BIOCIDE 122, or BIOCIDE 123, or BIOCIDE 124, or BIOCIDE 125, or BIOCIDE 126, or BIOCIDE 127, or BIOCIDE 128, or BIOCIDE 129, or BIOCIDE 130, or BIOCIDE 131, or BIOCIDE 132, or BIOCIDE 133, or BIOCIDE 134, or BIOCIDE 135, or BIOCIDE 136, or BIOCIDE 137, or BIOCIDE 138, or BIOCIDE 139, or BIOCIDE 140, or BIOCIDE 141, or BIOCIDE 142, or BIOCIDE 143, or BIOCIDE 144, or BIOCIDE 145, or BIOCIDE 146, or BIOCIDE 147, or BIOCIDE 148, or BIOCIDE 149, or BIOCIDE 150, or BIOCIDE 151, or BIOCIDE 152, or BIOCIDE 153, or BIOCIDE 154, or BIOCIDE 155, or BIOCIDE 156, or BIOCIDE 157, or BIOCIDE 158, or BIOCIDE 159, or BIOCIDE 160, or BIOCIDE 161, or BIOCIDE 162, or BIOCIDE 163, or BIOCIDE 164, or BIOCIDE 165, or BIOCIDE 166, or BIOCIDE 167, or BIOCIDE 168, or BIOCIDE 169, or BIOCIDE 170, or BIOCIDE 171, or BIOCIDE 172, or BIOCIDE 173, or BIOCIDE 174, or BIOCIDE 175, or BIOCIDE 176, or BIOCIDE 177, or BIOCIDE 178, or BIOCIDE 179, or BIOCIDE 180, or BIOCIDE 181, or BIOCIDE 182, or BIOCIDE 183, or BIOCIDE 184, or BIOCIDE 185, or BIOCIDE 186, or BIOCIDE 187, or BIOCIDE 188, or BIOCIDE 189, or BIOCIDE 190, or BIOCIDE 191, or BIOCIDE 192, or BIOCIDE 193, or BIOCIDE 194, or BIOCIDE 195, or BIOCIDE 196, or BIOCIDE 197, or BIOCIDE 198, or BIOCIDE 199, or BIOCIDE 200, or BIOCIDE 201, or BIOCIDE 202, or BIOCIDE 203, or BIOCIDE 204, or BIOCIDE 205, or BIOCIDE 206, or BIOCIDE 207, or BIOCIDE 208, or BIOCIDE 209, or BIOCIDE 210, or BIOCIDE 211, or BIOCIDE 212, or BIOCIDE 213, or BIOCIDE 214, or BIOCIDE 215, or BIOCIDE 216, or BIOCIDE 217, or BIOCIDE 218, or BIOCIDE 219, or BIOCIDE 220, or BIOCIDE 221, or BIOCIDE 222, or BIOCIDE 223, or BIOCIDE 224, or BIOCIDE 225, or BIOCIDE 226, or BIOCIDE 227, or BIOCIDE 228, or BIOCIDE 229, or BIOCIDE 230, or BIOCIDE 231, or BIOCIDE 232, or BIOCIDE 233, or BIOCIDE 234, or BIOCIDE 235, or BIOCIDE 236, or BIOCIDE 237, or BIOCIDE 238, or BIOCIDE 239, or BIOCIDE 240, or BIOCIDE 241, or BIOCIDE 242, or BIOCIDE 243, or BIOCIDE 244, or BIOCIDE 245, or BIOCIDE 246, or BIOCIDE 247, or BIOCIDE 248, or BIOCIDE 249, or BIOCIDE 250, or BIOCIDE 251, or BIOCIDE 252, or BIOCIDE 253, or BIOCIDE 254, or BIOCIDE 255, or BIOCIDE 256, or BIOCIDE 257, or BIOCIDE 258, or BIOCIDE 259, or BIOCIDE 260, or BIOCIDE 261, or BIOCIDE 262, or BIOCIDE 263, or BIOCIDE 264, or BIOCIDE 265, or BIOCIDE 266, or BIOCIDE 267, or BIOCIDE 268, or BIOCIDE 269, or BIOCIDE 270, or BIOCIDE 271, or BIOCIDE 272, or BIOCIDE 273, or BIOCIDE 274, or BIOCIDE 275, or BIOCIDE 276, or BIOCIDE 277, or BIOCIDE 278, or BIOCIDE 279, or BIOCIDE 280, or BIOCIDE 281, or BIOCIDE 282, or BIOCIDE 283, or BIOCIDE 284, or BIOCIDE 285, or BIOCIDE 286, or BIOCIDE 287, or BIOCIDE 289, or BIOCIDE 290, or BIOCIDE 291, or BIOCIDE 292, or BIOCIDE 293, or BIOCIDE 294, or BIOCIDE 295, or BIOCIDE 296, or BIOCIDE 297, or BIOCIDE 298, or BIOCIDE 299, or BIOCIDE 300, or BIOCIDE 301, or BIOCIDE 302, or BIOCIDE 303, or BIOCIDE 304, or BIOCIDE 305, or BIOCIDE 306, or BIOCIDE 307, or BIOCIDE 308, or BIOCIDE 309, or BIOCIDE 310, or BIOCIDE 311, or BIOCIDE 312, or BIOCIDE 313, or BIOCIDE 314, or BIOCIDE 315, or BIOCIDE 316, or BIOCIDE 317, or BIOCIDE 318, or BIOCIDE 319, or BIOCIDE 320, or BIOCIDE 321, or BIOCIDE 322, or BIOCIDE 323, or BIOCIDE 324, or BIOCIDE 325, or BIOCIDE 326, or BIOCIDE 327, or BIOCIDE 328, or BIOCIDE 329, or BIOCIDE 330, or BIOCIDE 331, or BIOCIDE 332, or BIOCIDE 333, or BIOCIDE 334, or BIOCIDE 335, or BIOCIDE 336, or BIOCIDE 337, or BIOCIDE 338, or BIOCIDE 339, or BIOCIDE 340, or BIOCIDE 341, or BIOCIDE 342, or BIOCIDE 343, or BIOCIDE 344, or BIOCIDE 345, or BIOCIDE 346, or BIOCIDE 347, or BIOCIDE 348, or BIOCIDE 349, or BIOCIDE 350, or BIOCIDE 351, or BIOCIDE 352, or BIOCIDE 353, or BIOCIDE 354, or BIOCIDE 355, or BIOCIDE 356, or BIOCIDE 357, or BIOCIDE 358, or BIOCIDE 359, or BIOCIDE 360, or BIOCIDE 361, or BIOCIDE 362, or BIOCIDE 363, or BIOCIDE 364, or BIOCIDE 365, or BIOCIDE 366, or BIOCIDE 367, or BIOCIDE 368, or BIOCIDE 369, or BIOCIDE 370, or BIOCIDE 371, or BIOCIDE 372, or BIOCIDE 373, or BIOCIDE 374, or BIOCIDE 375, or BIOCIDE 376, or BIOCIDE 377, or BIOCIDE 378, or BIOCIDE 379, or BIOCIDE 380, or BIOCIDE 381, or BIOCIDE 382, or BIOCIDE 383, or BIOCIDE 384, or BIOCIDE 385, or BIOCIDE 386, or BIOCIDE 387, or BIOCIDE 388, or BIOCIDE 389, or BIOCIDE 390, or BIOCIDE 391, or BIOCIDE 392, or BIOCIDE 393, or BIOCIDE 394, or BIOCIDE 395, or BIOCIDE 396, or BIOCIDE 397, or BIOCIDE 398, or BIOCIDE 399, or BIOCIDE 400, or BIOCIDE 401, or BIOCIDE 402, or BIOCIDE 403, or BIOCIDE 404, or BIOCIDE 405, or BIOCIDE 406, or BIOCIDE 407, or BIOCIDE 408, or BIOCIDE 409, or BIOCIDE 410, or BIOCIDE 411, or BIOCIDE 412, or BIOCIDE 413, or BIOCIDE 414, or BIOCIDE 415, or BIOCIDE 416, or BIOCIDE 417, or BIOCIDE 418, or BIOCIDE 419, or BIOCIDE 420, or BIOCIDE 421, or BIOCIDE 422, or BIOCIDE 423, or BIOCIDE 424, or BIOCIDE 425, or BIOCIDE 426, or BIOCIDE 427, or BIOCIDE 428, or BIOCIDE 429, or BIOCIDE 430, or BIOCIDE 431, or BIOCIDE 432, or BIOCIDE 433, or BIOCIDE 434, or BIOCIDE 435, or BIOCIDE 436, or BIOCIDE 437, or BIOCIDE 438, or BIOCIDE 439, or BIOCIDE 440, or BIOCIDE 441, or BIOCIDE 442, or BIOCIDE 443, or BIOCIDE 444, or BIOCIDE 445, or BIOCIDE 446, or BIOCIDE 447, or BIOCIDE 448, or BIOCIDE 449, or BIOCIDE 450, or BIOCIDE 451, or BIOCIDE 452, or BIOCIDE 453.

In particular, aqueous preparations which comprise organic compounds are often a good nutrient medium for microorganisms and should be preserved by adding biocides.

The liquid preparations generally comprise at least one solvent and at least one further chemical compound, whether it be an organic compound, e.g. including a polymer, or an inorganic compound. In general, preparations of this type comprise a large number of further different compounds which are desired or required for the particular intended application of the preparation.

Suitable solvents are water or organic solvents or mixtures of water and organic solvents, e.g. alcohols; in the latter case, they may be homogeneous mixtures or emulsions of water in organic solvents or vice versa (water in oil emulsions or oil in water emulsions). The further constituents of the preparation are dissolved, emulsified or dispersed in the solvent.

The diols can also be formulated in personal care products or household products which comprise one or more preservation boosters, such as e.g. ethylhexylglycerol, propylene glycol, butylene glycol, PEG 40-hydrogenated castor oil, 1,2-propanediol, 1,3-propanediol, 1,2-pentanediol, 1,2-hexanediol, 1,2-octanediol, 1,2-decanediol, 4-methyl-4-phenyl-2-pentanol.

The liquid preparations may be e.g. polymer, dispersion's or polymer solutions which optionally comprise further additives, e.g. pigments, dyes, stabilizers, thickeners, flow auxiliaries, emulsifiers and coemulsifiers, surfactants, oils, other preservatives, perfume oils, cosmetic care substances and active ingredients such as AHA acids, fruit acids, ceramides, phytantriol, collagen, vitamins and provitamins, for example vitamin A, E and C, retinol, bisabolol, panthenol, natural and synthetic photoprotective agents, natural substances, opacifiers, solubility promoters, repellants, bleaches, colorants, tinting agents, tanning agents (e.g. dihydroxyacetone) micropigments such as titanium oxide or zinc oxide, superfatting agents, pearlescent waxes, solubilizers, complexing agents, fats, waxes, silicone compounds, hydrotropes, dyes, pH regulators, reflectors, proteins and protein hydrolyzates, salts, gelling agents, further consistency regulators, silicones, humectants, refatting agents, UV photoprotective filters, antioxidants, antifoams, antistats, emollients, softeners, peroxides etc.

The preparations can also comprise antibacterial metal salts. This group comprises the metal salts of groups 3b-7b, 8 and 3a-5a. The salts of aluminum, zirconium, zinc, gold, silver and copper are particularly useful.

Furthermore, the preparation can also comprise complexing agents, e.g. EDTA, EDETA, chitosan derivatives or NTA. Such complexing agents can produce additional effects or synergistic effects together with the diols described here.

Diols can also be incorporated into hair care formulations or constitute applications which are active against dandruff. This is true particularly for combinations with other antimicrobial agents, such as e.g. zinc pyrithione, octopirox, climbazole, sulfur, imidazole derivatives, salicylic derivatives or proteins or peptides, as described e.g. in (WO 2009 080306 A1).

The diols can also be used as deodorant active ingredients for personal care and household applications, e.g. as underarm deodorant, underarm perspirant/deodorant, air freshening aerosols. The invention comprises in particular personal care and household deodorants which are combined with one or more representatives of the following selection: triclosan, triclocarban, organic acids, such as e.g. benzoic acid, sorbic acid, silver compounds, such as tinosan SDC or the diols described here. The invention moreover comprises personal care compositions which include one deodorant active ingredient and one or more antiperspirant active ingredients, such as e.g. aluminum chlorohydrate, zirconium chlorohydrate and other salts of aluminum, zinc or zirconium, alcohol, complexing agents or antioxidants.

Esterase inhibitors can also be added to the mentioned preparations as further deodorant active ingredient. Such inhibitors are particularly trialkyl citrates, such as trimethyl citrate, tripropyl citrate, triisopropyl citrate, tributyl citrate and particularly triethyl citrate (Hydagen CAT, Henkel). They inhibit the enzyme activity and thereby reduce the formation of body odors. Furthermore, sterol sulfates or phosphates, such as lanosterol, cholesterol, dicarboxylic acids and esters thereof can also as esterase inhibitors. In some preparations, such ingredients can enhance or qualitatively modify the antimicrobial effect of the diols described here.

The diols can be used alone or in mixtures for the treatment of acne. It is possible, for example, to use combinations of the diols described here with other substances, such as phenoxyethanol, phenoxypropanol, bezalconium chloride, cetrimonium bromide, benzethonium chloride or salicylic acid. If the mixture is applied to an area of skin affected by acne, the mixture will exert an antiacne effect.

A large variety of anionic surfactants may be useful in representations of this invention. Nonlimiting examples of anionic surfactants can be selected from the group of alkyl sulfates and alkyl ether sulfates or from the group of sulfonated monoglycerides, sulfonated olefins, alkylarylsulfonates, primary or secondary alkanesulfonates, alkylsulfosuccinates, acyl taurates, acyl isethionates, alkyl glyceryl ether sulfonates, sulfonated methyl esters, sulfonated fatty acids, alkyl phosphates, acyl glutamates, acyl sarcosinates, alkyl sulfoacetates, acylated peptides, alkyl ether carboxylates, acyl lactylates, anionic fluorosurfactants and mixtures thereof. Anionic surfactants can be used effectively for some representations of this invention.

The present invention comprises personal care and household applications which consist of one or more nonionic surfactants. Some nonionic surfactants are condensation products of ethylene oxide with quite different components which have reactive hydrogen atoms and long hydrophobic chains (C12-C20). Such products (ethoxamers) comprise long hydrophilic polyoxyethylene subunits, such as e.g. condensation products of poly(ethylene oxide) with fatty acids, fatty alcohols, fatty amides, polyhydric alcohols and polypropylene oxide.

Polyoxamers comprise e.g. block copolymers of polyoxyethylenes and polyoxypropylene with an average molecular weight of from 3000 to 5000 and a preferred average molecular weight of from 3500 to 4000. They include circa 10-80% hydrophilic polyoxyethylene groups, based on the weight of the block copolymer (e.g. Pluronic F127). Other nonionic surfactants are e.g. alkyl polyglucosides, alcanolamides, ethers of fatty acids with ethylene oxide or propylene oxide, amine oxides, e.g. cocamidopropylamine oxide.

The invention also includes preparations from the sectors of personal care and household products which comprise one or more amphoteric surfactants. Non-limiting examples of amphoteric surfactants are secondary or tertiary aliphatic amine derivatives in which the aliphatic chain, linear branched, of at least 8 to 22 carbon atoms and an anionic group, such as carboxylates, sulfonates, sulfates, phosphates or phosphonates, acyl/dialkylethylenediamines, acyl amphoacetates, disodium acylamphodipropionates, sodium acylamphohydroxypropylsulfonates, disodium acylamphoacetates, sodium acylamphopropionates, in which the acyl group represents either an alkyl or an alkenyl group, N-alkylamino acids or -imino acids, such as aminopropylalkylglutamide, alkylaminopropionic acid, sodium alkyliminopropionate, alkyl glycinate and carboxyglycinates or sodium cocoglycinates, C₈-C₁₈-betaine, C₈-C₁₈-sulfobetaine, C₈-C₂₄-alkylamido-C₁-C₄-alkylenebetaines, imidazolinecarboxylates, alkylamphocarboxycarboxylic acids, alkylamphocarboxylic acids (e.g. lauroamphoglycinate) and N-alkyl-β-aminopropionate or -iminodipropionate.

In specific representations, the amphoteric surfactants comprise C₁₀-C₂₀-alkylamido-C₁-C₄-alkylenebetaines and/or coconut fatty acid amidopropylbetaine.

The invention comprises preparations from the sectors of personal care and household products which consist of a combination of anionic, nonionic and amphoteric surfactants.

The diols can also be formulated together with mildness-enhancing” agents in personal care or household products. Such “mildness-enhancing” agents can be e.g. cationic and nonionic polymers, cosurfactants, moisturizing substances or mixtures thereof.

In the formulations described, in most cases, stabilizers are also incorporated in order to lead to improved stress stability and storage stability. In some representations, preference is given to using stabilizers comprising hydroxyl groups, such as e.g. 12-hydroxystearic acid, 9,10-dihydroxystearic acid, tri-9,10-dihydroxystearin and tri-12-hydroxystearin (hydrogenated castor oil consists primarily of tri-12-hydroxystearin). In some representations, the stabilizers which are added to the antimicrobial preparations consist of polymeric thickeners. A thickener is a substance which can increase the viscosity of a liquid preparation. Thickeners can be divided into two groups: those which develop the best effect in water-based formulations and those which develop the best effect in oil-based formulations.

Thickeners can also be divided according to their origin, e.g. synthetic polymers, natural polymers and their derivatives, mineral polymers or according to their ionic character (anionic, cationic, nonionic or amphoteric thickeners).

A further class of stabilizers which may be present in some antimicrobial preparations of the present invention comprise dispersed amorphous silica: e.g. evaporated silica, precipitated silica and mixtures thereof. The term “dispersed amorphous silica” refers to finely divided non-crystalline silica with an average particle size of silica agglomerates of less than 100 microns.

In some representations in which amorphous silica is used as stabilizer, it is added in the range from 0.1 to 10%, preferably in the range from 0.25-8% and particularly preferably in the range from 0.5-5%.

A further class of stabilizers which are used in he antimicrobial preparations of the present invention are the disperse clay-containing earths (dispersed smectide clay) from the group of bentonites and hectorites and mixtures thereof. Bentonite is a colloidal aluminum sulfate-containing loam. Hectorite is a loam consisting of sodium, magnesium, lithium, silicon, oxygen, hydrogen and fluorine. If disperse clay-containing earths are used in cleaning compositions, they are usually incorporated into the formulation from 0.1 to 10%, preferably from 0.25-8% and particularly preferably from 0.5 to 5%.

In the representations of the present invention, passivating agents can also be used for the stabilization, e.g. hectorite, bentonite, montmorollonite, nontronite, saponite, sauconite, beidellite, allevardite, illite, halloysite, attapulgite, sepiolite and/or talc. These substances are often used in deodorant products, aerosols or sticks in order to keep antiperspirants that are present in solution.

Further stabilizers, such as fatty acids or fatty alcohols, can likewise be used in a number of the formulations mentioned here.

Furthermore, yet further ingredients in addition to the diols may be present in antimicrobial preparations. These ingredients can be assigned inter alia to the following functional classes: abrasives, anti-acne active ingredients, anticaking active ingredients, antioxidants, binders, biological additives, bulking agents, complexing agents, chemical additives, dyes, cosmetic astringents, cosmetic biocides, denaturing agents, emulsifiers, emollients, film formers, perfumes, humectants, opaque pigments, preservatives, propellants, reducing agents, skin-bleaching substances, skin care agents, skin protectants, antiwrinkle active ingredients, adjuvants, solvents, foam boosters, hydrotropic agents, solubility promoters, dispersants, gel formers, sun protection agents, UV light filters, viscosity boosters or diminishers, antibiofilm active ingredients, antiplaque active ingredients, antigingivitis active ingredients, antiperiodontitis active ingredients, flavorings, sweeteners, fluorinating agents, enzymes, peptides.

For the use of the diols as preservatives in liquid preparations, particularly preparations which comprise water as solvent, whether it is the sole solvent or in a mixture with other solvents, are of importance.

The liquid preparations may be low-viscosity to high-viscosity preparations. In particular, aqueous preparations which comprise organic compounds are often a good nutrient medium for microorganisms and should be preserved by adding biocides.

The liquid preparations generally comprise at least one solvent and at least one further chemical compound, whether it be an organic compound, e.g. including a polymer, or an inorganic compound. In general, preparations of this type comprise a large number of further different compounds which are desired or required for the particular intended application of the preparation.

Suitable solvents are water or organic solvents or mixtures of water and organic solvents, e.g. alcohols; in the latter case, they may be homogeneous mixtures or emulsions of water in organic solvents or vice versa (water in oil emulsions or oil in water emulsions). The further constituents of the preparation are dissolved, emulsified or dispersed in the solvent.

The liquid preparations may be e.g. polymer dispersions or polymer solutions which optionally comprise further additives, e.g. pigments, dyes, stabilizers, thickeners, flow auxiliaries, emulsifiers and coemulsifiers, surfactants, oils, other preservatives, perfume oils, cosmetic care substances and active ingredients such as AHA acids, fruit acids, ceramides, phytantriol, collagen, vitamins and provitamins, for example vitamin A, E and C, retinol, bisabolol, panthenol, natural and synthetic photoprotective agents, natural substances, opacifiers, solubility promoters, repellants, bleaches, colorants, tinting agents, tanning agents (e.g. dihydroxyacetone) micropigments such as titanium oxide or zinc oxide, superfatting agents, pearlescent waxes, solubilizers, complexing agents, fats, waxes, silicone compounds, hydrotropes, dyes, pH regulators, reflectors, proteins and protein hydrolyzates, salts, gelling agents, further consistency regulators, silicones, humectants, refatting agents, UV photoprotective filters, antioxidants, antifoams, antistats, emollients, softeners, peroxides etc.

For the use of the 1,3-diols as preservatives in liquid preparations, in particular preparations which comprise water as solvent, whether it be as the only solvent or in a mixture with other solvents, are of importance.

The liquid preparations may be low-viscosity to high-viscosity preparations.

High-viscosity preparations are in particular also ointments, creams or gels.

Gaseous preparations are in particular sprays, e.g. as aerosol or pump spray.

As preparations, mention may furthermore be made of solids-stabilized formulations, stick formulations, PIT formulations, in the form of creams, foams, sprays (pump spray or aerosol), gels, gel sprays, lotions, oils, oil gels or mousse.

The liquid preparations (including high-viscosity preparations such as ointments or creams), gaseous preparations, sprays, foams or gels may be e.g. those for medical, hygiene, cosmetic or dermatological purposes; detergents or cleaners are also contemplated.

The content of the 1,3-diols in the preparations should preferably be at least 0.001, particularly preferably at least 0.01 and very particularly preferably at least 0.05 parts by weight of 1,3-diol per 100 parts by weight of the preparation. For the intended effect, it generally makes little sense to use more than 2 parts by weight or more than 1 part by weight of 1,3-diol per 100 parts by weight of the preparation.

When using the 1,3-diols as biocide, whether in the aforementioned preparations or for the biocidal finishing of moldings, it is possible to use a single defined 1,3-diol or a mixture of 1,3-diols. In particular, 1,3-diols can always also be used in combination with other biocides and thus support the effect of other biocides.

Being biocides, the 1,3-diols have an excellent effect against microorganisms such as viruses, yeasts, fungi, algae, and in particular against bacteria, whether they are Gram-negative or Gram-positive bacteria. They are therefore suitable for the biocidal finishing of moldings and for preserving liquid preparations, sprays, foams or gels in order to protect these against attack and growth of a very wide variety of microorganisms.

The invention comprises the use of diols of the formula (1) for antimicrobial treatment, for antimicrobial finishing, for the deodorization and disinfection of the skin, mucosa, tooth surfaces, nail surfaces and hair.

The invention comprises the use of diols of the formula (1) as an antidandruff agent in hair care products.

The invention comprises the use of diols of the formula (1) as antimicrobial active substance for the treatment of skin infections and mucosa infections and nails.

The invention comprises the use of diols of the formula (1) for treating injuries to the skin and mucosa.

The invention comprises the use of diols of the formula (1) as active substance of medical materials.

The invention comprises the use of diols of the formula (1) for the preservation, stabilization, antimicrobial treatment, disinfection and deodorization of inanimate surfaces and materials.

The invention comprises the use of diols of the formula (1) for the antimicrobial treatment of textiles.

The invention comprises the use of diols of the formula (1) for preserving household products, cosmetic products and pharmaceutical products and pharmaceutical products.

The invention comprises the use of diols of the formula (1) in detergent and cleaner formulations.

The invention comprises the use of diols of the formula (1) for the antibacterial finishing and preservation of plastic products, paper products, nonwoven materials, wood and leather.

The invention comprises the use of diols of the formula (1) for the antimicrobial finishing and the preservation of technical products.

The invention comprises the use of diols of the formula (1) as biocide in technical processes.

The invention comprises personal care products which comprise
a) 0.01 to 15% w/w with regard to the total mass of the formulation which comprises the substance which has been defined in claim 1 with formula (1)
b) cosmetically compatible ingredients.

The invention comprises oral care products which comprise
a) 0.01 to 15% w/w with regard to the total mass of the formulation which comprises the substance which has been defined in claim 1 with formula (1)
b) orally compatible ingredients.

The invention comprises pharmaceutical products which comprise
a) 0.01 to 15% w/w with regard to the total mass of the formulation which comprises the substance which has been defined in claim 1 with formula (1)
b) pharmaceutically compatible ingredients.

The invention comprises the use of diols of the formula (1) for inhibiting biofilms and/or destroying biofilms and/or inhibiting or killing microorganisms which are able to form biofilms.

### EXAMPLES

Various tests were carried out to evaluate the antimicrobial activities of the diols. Firstly, the microstatic activity was investigated in comparison with propylene glycol. Moreover, selected diols were incorporated into various cosmetic formulations for the purpose of preserving these formulations. Here too, the effectiveness of the diols was compared with the preserving activity of other comparable commercial products intended for preservation.

Microstatic Activity

The 1,3-diols were tested as biocides and, for comparison, propylene glycol (which was used as solvent), 1,2-pentanediol (high biocidal effect known) and 2,4-pentanediol (low biocidal effect).

For this, in each case a 40 percent strength by weight solution of a diol in propylene glycol was prepared at 60° C.

This solution was diluted with a double-strength soy solution (double-strength tryptone soy broth) as nutrient medium in the volume ratio 1:1. Further dilution with soy solution produced solutions with the following concentrations:

400 000 ppm (40%), 200 000 ppm (20%), 100 000 ppm (10%), 50 000 ppm (5%), 25 000 ppm (2.5%), 12 500 ppm (1.25%), 6250 ppm (0.625%), 3125 ppm (0.3125%).

The following microorganisms were used;to test the biocidal effect against various bacteria and fungi:

Bacteria:

P. aeruginosa NCIMB 10421

S. aureus NCIMB 9578

E. coli NCIMB 8545

P. vulgaris NCIMB 4175

Fungi:

C. albicans NCPF 3179

A. niger IMI 149007

Pure soy solution was used as negative control. The positive control used was a solution of 5 ml of soy solution which has been treated with 0.1 ml of the respective microorganism. The test solutions consisted of 5 ml of the above-described soy solutions of the diols in the particular concentration which have been mixed with 0.1 ml of the respective microorganism.

The samples and controls were incubated in the case of the bacteria at 30° C. for 48 hours, and in the case of fungi over 5 days at 25° C.

In each case, the MIC (Minimum Inhibitory Concentration) value was determined. This value indicates the minimum concentration above which the growth of the microorganisms was visibly hindered compared to the corresponding sample without addition of the diol.

The lower the MIC value, the greater the biocidal effect.

A test was deemed positive if the test solution was comparable with the positive control following visual assessment. For example, this was evident from the occurrence of clouding or visible growth of the microorganism. A test was deemed negative if the test solution had an identical appearance to the negative control.

The MIC value stated is a range between the next higher concentration of a positive test and the same and/or lower concentration of a first negative test.

In the last line of each of the tables below, a “maximum” value is listed. This value indicates the highest measured MIC value in each case from the series of tested microorganisms.

EMPD

| | MIC value (ppm of diol) | |
|---|---|---|
| Organism | from | to |
| P. aeruginosa | >12 500 | ≦25 000 |
| S. aureus | >25 000 | ≦50 000 |
| E. coli | >12 500 | ≦25 000 |
| P. vulgaris | >25 000 | ≦50 000 |
| C. albicans | >50 000 | ≦100 000 |
| A. niger | >50 000 | ≦100 000 |
| Maximum | >50 000 | ≦100 000 |

PPPD

| | MIC value (ppm of diol) | |
|---|---|---|
| Organism | from | to |
| P. aeruginosa | >100 000 | ≦200 000 |
| S. aureus | >50 000 | ≦100 000 |
| E. coli | >50 000 | ≦100 000 |
| P. vulgaris | >25 000 | ≦50 000 |
| C. albicans | >6250 | ≦12 500 |
| A. niger | >6250 | ≦12 500 |
| Maximum | >100 000 | ≦200 000 |

IMBPD

| | MIC value (ppm of diol) | |
|---|---|---|
| Organism | from | to |
| P. aeruginosa | >100 000 | ≦200 000 |
| S. aureus | >50 000 | ≦100 000 |
| E. coli | >25 000 | ≦50 000 |
| P. vulgaris | >50 000 | ≦100 000 |
| C. albicans | >25 000 | ≦50 000 |
| A. niger | >12 500 | ≦25 000 |
| Maximum | >100 000 | ≦200 000 |

MPPD

| | MIC value (ppm of diol) | |
|---|---|---|
| Organism | from | to |
| P. aeruginosa | >25 000 | ≦50 000 |
| S. aureus | >12 500 | ≦25 000 |
| E. coli | >0 | ≦3125 |
| P. vulgaris | >3125 | ≦6250 |
| C. albicans | >50 000 | ≦100 000 |
| A. niger | >50 000 | ≦100 000 |
| Maximum | >50 000 | ≦100 000 |

BEPD

| | MIC value (ppm of diol) | |
|---|---|---|
| Organism | from | to |
| P. aeruginosa | >50 000 | ≦100 000 |
| S. aureus | >12 500 | ≦25 000 |
| E. coli | >6250 | ≦12 500 |
| P. vulgaris | >3125 | ≦6250 |
| Cand | >25 000 | ≦50 000 |
| Asp | >12 500 | ≦25 000 |
| Maximum | >50 000 | ≦100 000 |

IMPD

| | MIC value (ppm of diol) | |
|---|---|---|
| Organism | from | to |
| P. aeruginosa | >12 500 | ≦25 000 |
| S. aureus | >12 500 | ≦25 000 |
| E. coli | >6250 | ≦12 500 |
| P. vulgaris | >6250 | ≦12 500 |
| C. albicans | >25 000 | ≦50 000 |
| A. niger | >25 000 | ≦50 000 |
| Maximum | >25 000 | ≦50 000 |

OMPD

| | MIC value (ppm of diol) | |
|---|---|---|
| Organism | from | to |
| P. aeruginosa | >100 000 | ≦200 000 |
| S. aureus | >25 000 | ≦50 000 |
| E. coli | >50 000 | ≦100 000 |
| P. vulgaris | >50 000 | ≦100 000 |
| C. albicans | >0 | ≦3125 |
| A. niger | >3125 | ≦6250 |
| Maximum | >100 000 | ≦200 000 |

DMCP

| | MIC value (ppm of diol) | |
|---|---|---|
| Organism | from | to |
| P. aeruginosa | >12 500 | ≦25 000 |
| S. aureus | >3125 | ≦6250 |
| E. coli | >3125 | ≦6250 |
| P. vulgaris | >12 500 | ≦25 000 |
| C. albicans | >25 000 | ≦50 000 |
| A. niger | >50 000 | ≦100 000 |
| Maximum | >50 000 | ≦100 000 |

DMCH

| | MIC value (ppm of diol) | |
|---|---|---|
| Organism | from | to |
| P. aeruginosa | >12 500 | ≦25 000 |
| S. aureus | >12 500 | ≦25 000 |
| E. coli | >6250 | ≦12 500 |
| P. vulgaris | >12 500 | ≦25 000 |
| C. albicans | >25 000 | ≦50 000 |
| A. niger | >25 000 | ≦50 000 |
| Maximum | >25 000 | ≦50 000 |

DMCO

| | MIC value (ppm of diol) | |
|---|---|---|
| Organism | from | to |
| P. aeruginosa | >12 500 | ≦25 000 |
| S. aureus | >6 250 | ≦12 500 |
| E. coli | >3 125 | ≦6 250 |
| P. vulgaris | >6 250 | ≦12 500 |
| C. albicans | >6 250 | ≦12 500 |
| A. niger | >6 250 | ≦12 500 |
| Maximum | >12 500 | ≦25 000 |

DMCOE

| | MIC value (ppm of diol) | |
|---|---|---|
| Organism | from | to |
| P. aeruginosa | >12 500 | ≦25 000 |
| S. aureus | >6250 | ≦12 500 |
| E. coli | >3125 | ≦6250 |
| P. vulgaris | >3125 | ≦6250 |
| C. albicans | >12 500 | ≦25 000 |
| A. niger | >12 500 | ≦25 000 |
| Maximum | >12 500 | ≦25 000 |

2,2-DMNB

| | MIC value (ppm of diol) | |
|---|---|---|
| Organism | from | to |
| P. aeruginosa | >12 500 | ≦25 000 |
| S. aureus | >12 500 | ≦25 000 |
| E. coli | >3125 | ≦6250 |
| P. vulgaris | >6250 | ≦12 500 |
| C. albicans | >50 000 | ≦100 000 |
| A. niger | >25 000 | ≦50 000 |
| Maximum | >50 000 | ≦100 000 |

1,2-Pentanediol

| | MIC value (ppm of diol) | |
|---|---|---|
| Organism | from | to |
| P. aeruginosa | >12 500 | ≦25 000 |
| S. aureus | >25 000 | ≦50 000 |
| E. coli | >25 000 | ≦50 000 |
| P. vulgaris | >25 000 | ≦50 000 |
| C. albicans | >25 000 | ≦50 000 |
| A. niger | >12 500 | ≦25 000 |
| Maximum | >25 000 | ≦50 000 |

2,4-Pentanediol Propylene glycol

| | MIC value (ppm of diol) | |
|---|---|---|
| Organism | from | to |
| P. aeruginosa | >50 000 | ≦100 000 |
| S. aureus | >50 000 | ≦100 000 |
| E. coli | >50 000 | ≦100 000 |
| P. vulgaris | >50 000 | ≦100 000 |
| C. albicans | >50 000 | ≦100 000 |
| A. niger | >200 000 | ≦400 000 |
| Maximum | >200 000 | ≦400 000 |

| | MIC value (ppm of diol) | |
|---|---|---|
| Organism | from | to |
| P. aeruginosa | >100 000 | ≦200 000 |
| S. aureus | >200 000 | ≦400 000 |
| E. coli | >200 000 | ≦400 000 |
| P. vulgaris | >100 000 | ≦200 000 |
| C. albicans | >200 000 | ≦400 000 |
| A. niger | >200 000 | ≦400 000 |
| Maximum | >200 000 | ≦400 000 |

Microbicidal Activity

The bactericidal activity of the substances of this invention was carried out in a suspension test corresponding to the European standard EN 1040 and compared with the activities of customary commercial products. For this, only relatively small modifications were made.

A selection of the 1,3-diols described here was tested against Gram-positive and Gram-negative bacteria, and also against yeasts and molds. A selection of the results is shown in table 2.

The substances of the formula (1) were dissolved in water or ethanol to give a 1% strength stock solution.

For determining the bactericidal activities, the test mixtures were selected such that 1000 ppm of active substance was present in an aqueous solution. The procedure was the same with the comparison samples.

For the results shown in table 2, the test mixtures were inoculated with the following bacterial strains such that the stated germ densities were present in the test mixtures.

E. coli ATCC 10536 1−2×10⁷ CFU/ml

S. aureus ATCC 6538 1−2×10⁷ CFU/ml

P. aeruginosa ATCC 15442 1−2×10⁷ CFU/ml

The test mixtures were incubated at room temperature (22° C.+/−2° C.). After defined contact times, aliquots of 1 ml were taken in order to determine the surviving germ count. For the deactivation of the microbicidal activity of the diols, the aliquots were diluted in 1:10 dilution steps in a solution of TS broth with 10% Tween, 3% lecithin, 0.1% histidines and 0.5% sodium thiosulfate and the 10⁻² and 10⁻³ dilution stages were used for determining the surviving germ count. For this purpose, corresponding aliquots were plated out on Caso medium with inhibitor (Merck) and incubated at 37° C. for 24 h.

The fungicidal activity was determined in accordance with European standard EN 1275 and compared with the activities of customary commercial products, with only slight modifications having been carried out.

The substances of the formula (1) were dissolved in water or ethanol to give a 1% strength stock solution.

To determine the microbicidal activities of the diols against yeasts, the test mixtures were selected such that 1000 ppm of active substance was present in an aqueous solution.

To determine the fungicidal effect against maids, an active concentration of 1% was selected in the test. The procedure was the same with the comparison samples.

For the results shown in table 2, the test mixtures were inoculated with the following yeast and mold strains such that the stated germ densities were present in the test mixtures.

C. albicans ATCC 10231 1−2×10⁶ CFU/ml

A. niger ATCC 16404 1−2.5×10⁵ CFU/ml

The test mixtures were incubated at room temperature (22° C.+/−2° C.). After defined contact times, aliquots of 1 ml were taken in order to determine the surviving germ count. For the deactivation of the microbicidal activity of the diols, the aliquots were diluted in 1:10 dilution steps in a solution of Sabouraud medium with 10% Tween, 3% lecithin, 0.1% histidines and 0.5% sodium thiosulfate and the 10⁻², 10⁻³ and 10⁻⁴ dilution stages were used for determining the surviving germ count. For this, corresponding aliquots were plated out on Sabouraud medium with inhibitor and incubated at 30° C. for 2 d.

The ascertained surviving germ counts were in each case compared with a mixture containing water (water control) by determining the logarithmic reduction in the surviving germ counts based on the water control.

A selection of the test results is shown in table 2.

TABLE 2
Results of the suspension tests carried out in order to compare the microbicidal activities of the diols with various commercial products

| | | Microbicidal activity given as logarithmic reduction in germ count [log. red.] | | | | | | |
|---|---|---|---|---|---|---|---|---|
| | | -1000 ppm of active substance in the test- | | | | | | |
| Germ | Contact time | | | | Symrise | Straetmanns | Straetmanns | Straetmanns |
| [1-2 × 10\hat{ }7 CFU/ml] | [min, h, d] | OMPD | PPPD | 1,2-Pentanediol | Hydrolite 5 | Dermosoft OMP | Dermsosoft LP | Dermosoft |
| E. coli ATCC 10536 | 5 min | >5 | >5 | <1 | <1 | <1 | <1 | <1 |
| | 30 min | >5 | >5 | <1 | <1 | <1 | <1 | 1.1 |
| | 24 h | >5 | >5 | <1 | <1 | <1 | 3.4 | <1 |
| S. aureus ATCC 6538 | 5 min | <1 | <1 | <1 | <1 | <1 | <1 | <1 |
| | 30 min | 4.8 | 1.5 | <1 | <1 | <1 | <1 | <1 |
| | 24 h | >5 | >5 | <1 | <1 | <1 | <1 | >5 |
| P. aeruginosa | 5 min | 4.5 | 3.2 | <1 | <1 | <1 | <1 | <1 |
| ATCC15442 | 30 min | 4.7 | 3.1 | — | — | <1 | <1 | <1 |
| Germ | Contact time | | | | | | | |
| [1-2 × 10\hat{ }6 CFU/ml] | [min, h, d] | -1000 ppm of active substance in the test- | | | | | | |
| C. albicans ATCC | 5 min | >4 | 1.7 | — | — | <1 | <1 | 2.3 |
| 10231 | 30 min | >4 | >5 | — | — | <1 | <1 | >4 |
| | 24 h | >4 | >5 | — | — | <1 | <1 | >4 |
| Germ | Contact time | | | | | | | |
| [1-2.5 × 10\hat{ }5 CFU/ml] | [min, h, d] | -1% active substance in the test- | | | | | | |
| A. niger ATCC 6275 | 24 h | <1 | 2.9 | <1 | <1 | <1 | <1 | 2.3 |
| | 7 d | 2.6 | >4 | <1 | <1 | <1 | <1 | 2.3 |

Preserving Activity of the Diols

Preservation stress tests (PSTs) were carried out in order to determine the preserving activity of the diols.

The method serves to ascertain an adequate preservation in the case of manufactured products such as cosmetics and household products and also technical raw materials (dyes, liquid soaps, shampoos, emulsions, creams, etc.).

In practice, the products are stored, possibly opened several times, refilled, etc. This can result in contamination due to microorganisms.

In the preservation stress test, this is simulated through artificial loadings with microorganisms. These can either be inoculated as mixed population or individually in mixtures independent of one another. The inoculated product samples are incubated under defined conditions and, after defined times, samples are taken in order to determine the germ loading. In the case of adequate preservation, the number of microorganisms should, depending on the type, either decrease or remain constant in order to satisfy the requirements specified, e.g. in Ph. Eur. 6.0.

To investigate the preserving effect of the diols, application-typical amounts of the diols were incorporated into example formulations. The preservation of these formulations by means of the diols present was compared with the preservation of the formulations by means of various comparable reference products at the same concentration.

### Example Formulation 1

### Standard Emulsion O/W

| | | | | 1% active |
|---|---|---|---|---|
| Phase | Ingredient | INCI | Placebo | substance |
| A | Cremophor A 6 | Ceteareth-6, | 2 | 2 |
| | | Stearyl Alcohol | | |
| | Cremophor A 25 | Ceteareth-25 | 2 | 2 |
| | Tegosoft Liquid | Cetearyl Ethyl- | 5 | 5 |
| | | hexanoate | | |
| | Paraffin oil, | Mineral oil | 5 | 5 |
| | high-visc. | | | |
| | Lanette 16 | Cetyl Alcohol | 2.5 | 2.5 |
| B | Water dem. | Aqua | ad 100 | ad 100 |
| | | Diols | 0 | 1 |
| pH | | | ca. 6.5 | ca. 6.5 |

### Example Formulation 2

### Roll-On Deodorant Formulation

| | | | | 1% active |
|---|---|---|---|---|
| Phase | Ingredient | INCI | Placebo | substance |
| A | Arlamol HD | Isohexadecane | 8.00 | 8.00 |
| | Tegosoft CT | Caprylic/Capric | 5.00 | 5.00 |
| | | Triglyceride | | |
| | Cetiol OE | Stearyl Ether | 3.00 | 3.00 |
| | Arlatone 983 | PEG-5 Glyceryl | 2.00 | 2.00 |
| | | Stearate | | |
| | Brij 76 NENA | Steareth-10 | 2.00 | 2.00 |
| | Lanette 16 | Cetyl Alcohol | 0.50 | 0.50 |
| B | Water | Water | 84.15 | 83.05 |
| | Propylene Glycol | Propylene Glycol | 2.00 | 2.00 |
| | Atlas G-2330 | Sorbeth-30 | 1.00 | 1.00 |
| C | | Diol | 0.00 | 1.00 |
| D | Sodium Hydroxide | Water (and) Sodium | ad 100 | ad 100 |
| | (1% solution) | Hydroxide | | |
| pH | | | 5.76 | 5.76 |

These example formulations were used to prepare various mixtures which each comprised 1% active substance or comprised water instead of the active substance as placebo mixtures.

These mixtures were in each case inoculated with the test germs such that a germ loading of 10⁵-10⁶ CFU/g was present in the test mixture. The bacteria were either used individually for the inoculation or as a mixed culture.

To determine the starting germ count, immediately after inoculation, an aliquot was taken, diluted in dilution medium (phosphate buffer, 0.07 molar pH 7.4 (+/−0.2), with 1% Tween 80+0.3% soya lecithin), and the surviving germ count was determined in the dilution stages 10⁻¹ to 10⁻³.

The inoculated product samples then incubated for a total of 28 d at 20-25° C. After 2 d, 7 d, 14 d and after 28 d, aliquots were taken and diluted in dilution medium (phosphate buffer, 0.07 molar pH 7.4 (+/−0.2), with 1% Tween 80+0.3% soya lecithin). The surviving germ counts were determined in the dilution stages 10⁻¹ to 10⁻⁴. The reference point taken for determining the reduction in germ count was the respective initial value of the sample. The results were given as logarithmic reductions.

The following strains were used for the tests:

E. coli ATCC 10536

S. aureus ATCC 6538

P. aeruginosa ATCC 15442

C. albicans ATCC 10231

A. niger ATCC 16404

The results of the preservation stress test with example formulation 1 and 2 are shown in the tables below.

TABLE 2.1
Results of the PSTs in example formulation 1 (standard
emulsion O/W), Reference products

| | | | Microbicidal activity given as logarithmic | | | |
|---|---|---|---|---|---|---|
| | | | reduction in germ count [log. Red.] | | | |
| | | | 1% active substance | | | |
| | | | present in the formulation | | | |
| Germ | Contact | | | 1,2- | Symrise ® | 1,2- |
| [2 × 10\hat{ }5 | time | | | Pentane- | Hydrolite | Hexane- |
| CFU/ml] | [min] | | Placebo | diol | 5 ® | diol |
| E. coli | 48 | h | 0 | 0 | 0 | 0 |
| ATCC | 7 | d | 0 | 0 | 0 | 1 |
| 10536 | 14 | d | 0 | 0 | 0 | 2 |
| | 28 | d | 0 | NT | NT | ≧3 |
| S. aureus | 48 | h | 0 | 0 | 0 | 1 |
| ATCC | 7 | d | 0 | 0 | 0 | 1 |
| 6538 | 14 | d | 0 | 0 | 0 | ≧3 |
| | 28 | d | 0 | NT | NT | 5 |
| P. aeruginosa | 48 | h | 0 | 0 | 0 | 0 |
| ATCC | 7 | d | ≧3 | ≧3 | 5 | 1 |
| 15442 | 14 | d | ≧3 | ≧3 | 5 | 1 |
| | 28 | d | 5 | NT | NT | ≧3 |
| C. albicans | 48 | h | 0 | 0 | 0 | 0 |
| ATCC | 7 | d | 0 | 0 | 0 | 0 |
| 10231 | 14 | d | 0 | 0 | 0 | 0 |
| | 28 | d | 0 | NT | NT | 1 |
| A. niger | 48 | h | 0 | 0 | 0 | 0 |
| ATCC | 7 | d | 0 | 0 | 0 | 0 |
| 16404 | 14 | d | 0 | 0 | 0 | 0 |
| | 28 | d | 0 | NT | NT | 0 |

TABLE 2.1
Results of the PSTs in example formulation 1
(standard emulsion O/W), Diols

| | | Microbicidal activity given as logarithmic | | | | | |
|---|---|---|---|---|---|---|---|
| | | reduction in germ count [log. Red.] - | | | | | |
| Germ | Contact | 1% active substance present in the formulation | | | | | |
| [2 × 10\hat{ }5 | time | | | | 2,2- | | |
| CFU/ml] | [min] | Placebo | IMPD | DMCP | DMNB | OMPD | PPPD |
| E. coil | 48 h | 0 | ≧3 | 3 | ≧3 | ≧3 | ≧3 |
| ATCC 10536 | | | | | | | |
| S. aureus | 7 d | 0 | 5 | 5 | 5 | 5 | 5 |
| ATCC 6538 | | | | | | | |
| P. aeruginosa | 14 d | 0 | 5 | 5 | 5 | 5 | 5 |
| ATCC 15442 | 28 d | 0 | 5 | 5 | 5 | 5 | 5 |
| C. albicans | 48 h | 0 | 1 | ≧3 | 1 | ≧3 | ≧3 |
| ATCC 10231 | 7 d | 1 | ≧3 | 5 | ≧3 | 5 | 5 |
| | 14 d | 1 | 5 | 5 | 5 | 5 | 5 |
| | 28 d | 1 | 5 | 5 | 5 | 5 | 5 |
| A. niger | 48 h | 0 | 1 | 2 | 0 | 0 | 0 |
| ATCC 16404 | 7 d | 0 | 1 | 1 | 0 | 0 | 1 |
| | 14 d | 0 | 2 | 2 | 0 | 1 | 1 |
| | 28 d | 0 | 3 | 2 | 0 | 1 | 1 |

TABLE 2.2

| | | Microbicidal activity given as logarithmic reduction ingerm count | | | | | | | |
|---|---|---|---|---|---|---|---|---|---|
| | | [log. Red.] - 1% active substance present in the formulation | | | | | | | |
| | Contact | | | | | | | | |
| Germ | time | | | | | | | | Symrise |
| [2 × 10\hat{ }5 CFU/ml] | [min] | Placebo | IMPD | DMCP | 2,2-DMNB | OMPD | PPPD | 1,2-Pentanediol | Hydrolite 5 |
| E. coli ATCC | 48 h | 0 | 3 | 1 | 2 | 0 | ≧3 | 0 | 0 |
| 10536 | 7 d | 0 | 5 | 3 | ≧3 | ≧3 | 5 | 1 | 0 |
| | 14 d | 0 | 5 | 5 | 5 | 5 | 5 | 1 | 0 |
| | 28 d | 0 | 5 | 5 | 5 | 5 | 5 | NT | NT |
| S. aureus ATCC | 48 h | 1 | ≧3 | ≧3 | ≧3 | ≧3 | 5 | 1 | 1 |
| 6538 | 7 d | 0 | 5 | 5 | 5 | 5 | 5 | 1 | 3 |
| | 14 d | 1 | 5 | 5 | 5 | 5 | 5 | 5 | 3 |
| | 28 d | 1 | 5 | 5 | 5 | 5 | 5 | NT | NT |
| P. aeruginosa ATCC | 48 h | 0 | 1 | 1 | 3 | ≧3 | 5 | 0 | 0 |
| 15442 | 7 d | 0 | ≧3 | ≧3 | 5 | 5 | 5 | 3 | ≦3 |
| | 14 d | ≧3 | 5 | 5 | 5 | 5 | 5 | 5 | 5 |
| | 28 d | ≧3 | 5 | 5 | 5 | 5 | 5 | NT | NT |
| C. albicans ATCC | 48 h | 0 | 0 | 0 | 0 | 0 | 0 | 0 | 0 |
| 10231 | 7 d | 0 | 0 | 0 | ≧3 | 0 | 0 | 0 | 0 |
| | 14 d | 0 | 0 | 0 | 0 | 0 | 0 | 0 | 0 |
| | 28 d | NT | NT | NT | NT | NT | NT | NT | NT |
| A. niger ATCC | 48 h | 0 | 0 | 0 | 0 | 0 | 0 | 0 | 0 |
| 16404 | 7 d | 0 | 0 | 0 | 0 | 0 | 0 | 0 | 0 |
| | 14 d | 0 | 0 | 0 | 0 | 0 | 0 | 0 | 0 |
| | 28 d | NT | NT | NT | NT | NT | NT | NT | NT |

1. A method of achieving a biocidal effect by coating, impregnating or treating a material with a diol of the formula I 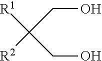
in which R1 and R2, independently of one another, are an organic radical having in each case at least one carbon atom, or R1 and R2 together form a ring system of at least 4 carbon atoms, which may be optionally substituted.

2. The method according to claim 1, wherein R1 and R2, independently of one another, are a hydrocarbon radical having 1 to 12 carbon atoms, or R1 and R2 together form a cycloaliphatic ring system.

3. The method according to claim 1, wherein R1 and R2, independently of one another, are a C1 to C12-alkyl group and the sum of the carbon atoms in R1 and R2 is at most 16.

4. The method according to claim 1, wherein R1 and R2, independently of one another, are a C1 to C10-alkyl group and the sum of the carbon atoms in R1 and R2 is at most 12.

5. The method according to claim 1, wherein R1 and R2 form a cycloaliphatic ring system having in total at most 12 carbon atoms and optionally a double bond in the ring system.

6. The method according to claim 1, wherein the
1,3-diol is
2-methyl-2-phenylpropane-1,3-diol (MPPD),
2-cyclohexyl-2-methylpropane-1,3-diol (CHMPD),
2-ethyl-2-methylpropane-1,3-diol (EMPD),
2-butyl-2-ethylpropane-1,3-diol (BEPD),
2-pentyl-2-propylpropane-1,3-diol (PPPD),
2-(2-methylbutyl)-2-propylpropane-1,3-diol (MBPPD),
2-isopropyl-2-methylpropane-1,3-diol (IMPD),
2-isopropyl-2-(3-methylbutyl)propane-1,3-diol (IMBPD),
2-octyl-2-methylpropane-1,3-diol (OMPD),
1,1-dimethylolcyclopentane (DMCP),
1,1-dimethylolcyclohexane (DMCH),
1,1-dimethylolcyclooct-4-ene (DMCOE),
1,1-dimethylolcyclooctane (DMCO),
1,1-dimethylolcyclododecane (DMCD) or
2,2-dimethylolnorbornane (2,2-DMNB)
or mixtures thereof.

7. The method according to claim 1 wherein the coating is a biocidal finish and the material is a molding.

8. The method according to claim 7, wherein the 1,3-diols or solutions or emulsions which comprise 1,3-diols of formula I are applied to the surface of the moldings.

9. The method according to claim 7, wherein the moldings is a moldings for medical applications, for applications in the sanitary and hygiene sector, for the packing or storage of foods or for filters in air conditioning systems.

10. A biocidally finished molding obtainable through a use according to claim 7.

11. The method according to claim 1, wherein the material is liquid preparations, gaseous preparations, sprays, foams or gels.

12. The method according to claim 11, wherein the liquid preparations, gaseous preparations, sprays, foams or gels are aqueous which comprise organic compounds.

13. The method according to claim 11, wherein the liquid preparations, gaseous preparations, sprays, foams or gels are polymer dispersions or polymer solutions.

14. The method according to claim 11, wherein the liquid preparations, gaseous preparations, sprays, foams or gels are medicinal, hygiene, cosmetic or dermatological preparations or detergents or cleaners.

15. A liquid preparation comprising a 1,3-diol according to claim 1 and at least one polymer.
